(19) United States
(12) Patent Application Publication
(10) Pub. No.: US 2007/0198256 A1
(43) Pub. Date: Aug. 23, 2007

(54) METHOD FOR MIDDLE/SIDE STEREO ENCODING AND AUDIO ENCODER USING THE SAME

(75) Inventors: Feng-Duo Hu, Hsinchu (TW); Feng-Dong Xu, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ITE TECH. INC., Hsinchu (TW)

(21) Appl. No.: 11/464,202

(22) Filed: Aug. 13, 2006

(30) Foreign Application Priority Data
Feb. 20, 2006 (TW) 95105606

(51) Int. Cl. G10L 19/02

(52) U.S. Cl. 704/229; 704/212

(57) ABSTRACT

An audio encoder includes a time-frequency mapping block, a psychoacoustic model block, a middle/side (M/S) encoding block, a parameter calculation block, a bit allocation and quantization block and a bitstream formatting block. The encoder is forced to operate in M/S mode for reducing the calculation time of the parameter used for bit allocation, quantization and encoding. In addition, the calculation of the parameter only needs to consider the middle and side channels but not the left and right channels, thus the complexity of the psychoacoustic model for analyzing the input audio signal can be reduced.

### CROSS-REFERENCE TO RELATED APPLICATION

This application claims the priority benefit of Taiwan application serial no. 95105606, filed on Feb. 20, 2006. All disclosure of the Taiwan application is incorporated herein by reference.

### BACKGROUND OF THE INVENTION

1. Field of Invention

The present invention relates to an audio encoder. More particularly, the present invention relates to an audio encoder using the method for middle/side stereo encoding.

2. Description of Related Art

Although there are great developments of internet, wireless communication and storage devices, digital audio still faces some serious challenges, such as wireless environment with a limited bandwidth, portable devices with a limited storage capacity, and requirements for low cost. The key technology meeting the above challenges is the MPEG (Motion Pictures Experts Group) audio standard. The MPEG audio standard divides audio compression standards into three layers: Layer-1, Layer-2 and Layer-3, wherein Layer-3 is the most complicated one but provides a best compression quality. The so-called MP3 (“MPEG Audio Layer-3” for short) music is the product of Layer-3.

For stereo encoding, MP3 provides a middle/side (M/S) stereo encoding, which can remove the irrelevancy and redundancy between left and right channel so as to complete the channel encoding with less bits. In M/S stereo encoding, normalized frequency samples of middle and side channels can be obtained from the following equations:

Mᵢ=(Lᵢ+Rᵢ)/\sqrt{2}

Sᵢ=(Lᵢ−Rᵢ)/\sqrt{2}

### Wherein Lᵢ and Rᵢ respectively express the frequency samples of left and right channels while Mᵢ and Sᵢ respectively express the frequency samples of middle and side channels.

FIG. 1 is a block drawing of an MP3 encoder using M/S stereo encoding, disclosed in the paper “M/S Coding Based on Allocation Entropy” submitted by C. M. Liu et al. in the sixth international conference on Digital Audio Effects (DAFX-03) in 2003. The M/S decision of the MP3 encoder is based on a new perceptual audio encoding, so-called allocation entropy (AE). Thus, this M/S encoding method has a better compression quality and a lower complexity.

Referring to FIG. 1, MP3 encoder 10 includes a filter bank 11, a psychoacoustic model block 12, a parameter calculation block 13, an M/S decision block 14, an M/S encoding block 15, a bit allocation and quantization block 16 and a bitstream formatting block 17. Usually, a sampled music signal is modulated by pulse code modulation (PCM) to become a PCM signal. The filter bank 11 maps the inputted PCM signal from time domain to frequency domain and divides the frequency-domain PCM signal into a plurality of subband signals, wherein the subband signals are in different subbands, respectively, and the subbands are close to the critical bands of human ears. At the same time, the inputted PCM signal is also inputted to the psychoacoustic model block 12, which decides those data that could be abandoned according to some characteristics of human hearing, and then transfers an analyzed result to the parameter calculation block 13 and the bit allocation and quantization block 16.

According to the left (L) channel, right (R) channel, middle (M) channel and side (S) channel of each of the subband signals outputted by the filter bank 11, the parameter calculation block 13 respectively calculates and provides the AE of each subband signal to the M/S decision block 14 to decide whether the encoder operates in M/S mode or not. If the M/S decision block 14 decides that the encoder operates in M/S mode, each subband signal will be first encoded in the M/S encoding block 15 and then sent to the bit allocation and quantization block 16. Contrarily, each subband signal will be sent to the bit allocation and quantization block 16 directly, not through the M/S encoding block 15 any more.

According to the information from the psychoacoustic model block 12, the signals decided to be sent by the M/S decision block 14, and a bit budget provided by a target bitrate, the bit allocation and quantization block 16 performs quantization and encoding to each subband signal in a proper bit number. Last, the bitstream formatting block 17 packs data quantized by the bit allocation and quantization block 16 into a plurality of MP3 frames, and then outputs the encoded audio signal.

However, the M/S encoding method used by the MP3 encoder 10 needs to calculate masking threshold from L, R, M and S channels to decide AE, so a great deal of time would be spent in the calculation.

### SUMMARY OF THE INVENTION

Accordingly, the present invention is directed to provide a method for M/S stereo encoding and an audio encoder using the method to more efficiently perform a stereo encoding to inputted audio signal.

The present invention provides an audio encoder including a time-frequency mapping block, a psychoacoustic model block, a middle/side (M/S) encoding block, a parameter calculation block, a bit allocation and quantization block and a bitstream formatting block. Wherein, the time-frequency mapping block is, for example, a multiphase filter bank and used to receive an audio signal, map the audio signal from time domain to frequency domain and divide the frequency-domain audio signal into a plurality of subband signals. Next, the M/S encoding block performs an M/S encoding to each subband signal to generate a corresponding M/S encoding subband signal. Then, the psychoacoustic model block analyzes the audio signal by means of its psychoacoustic model.

Next, according to the analysis result of the psychoacoustic model block and M channel and S channel in the M/S encoding subband signal, the parameter calculation block generates an AE corresponding to the M/S encoding subband signal. According to the analysis result of the psychoacoustic model block and the AE, the bit allocation and quantization block performs bit allocation, quantization and encoding to the M/S encoding subband signal corresponding to the AE to generate a quantization encoding signal. Last, the bitstream formatting block outputs the quantization encoding signal corresponding to each subband signal in bitstream format.

In addition, the present invention provides a method for M/S stereo encoding. In the method, an audio signal is first received and analyzed through the psychoacoustic model. Then, the audio signal is mapped from time domain to frequency domain and divided into a plurality of subband signals. M/S encoding is performed to each of the subband signals to generate a corresponding M/S encoding subband signal. Next, according to the analysis result of the psychoacoustic model and the M channel and S channel in the M/S encoding subband signal, a corresponding AE is generated. According to the analysis result of the psychoacoustic model and the AE, a bit allocation, quantization and encoding are performed to generate a quantization encoding signal. Last, the quantization encoding signal corresponding to each subband signal is outputted in the bitstream format.

In the present invention, the encoder is forced to operate in M/S mode to reduce the calculation time of the parameter needed by the bit allocation and quantization. In addition, the calculation of the parameter needs only to consider M and S channels, but not L and R channels, thus, the complexity of the psychoacoustic model for analyzing the input audio signal can be reduced.

In order to make the aforementioned and other objects, features and advantages of the present invention comprehensible, a preferred embodiment accompanied with figures is described in detail below.

### BRIEF DESCRIPTION OF THE DRAWINGS

FIG. 1 is a block drawing of a conventional MP3 encoder using M/S stereo encoding.

FIG. 2 is a block drawing of an MP3 encoder using M/S stereo encoding according to an embodiment of the present invention.

FIG. 3 is a flow chart of the method for M/S stereo encoding according to an embodiment of the present invention.

### DESCRIPTION OF EMBODIMENTS

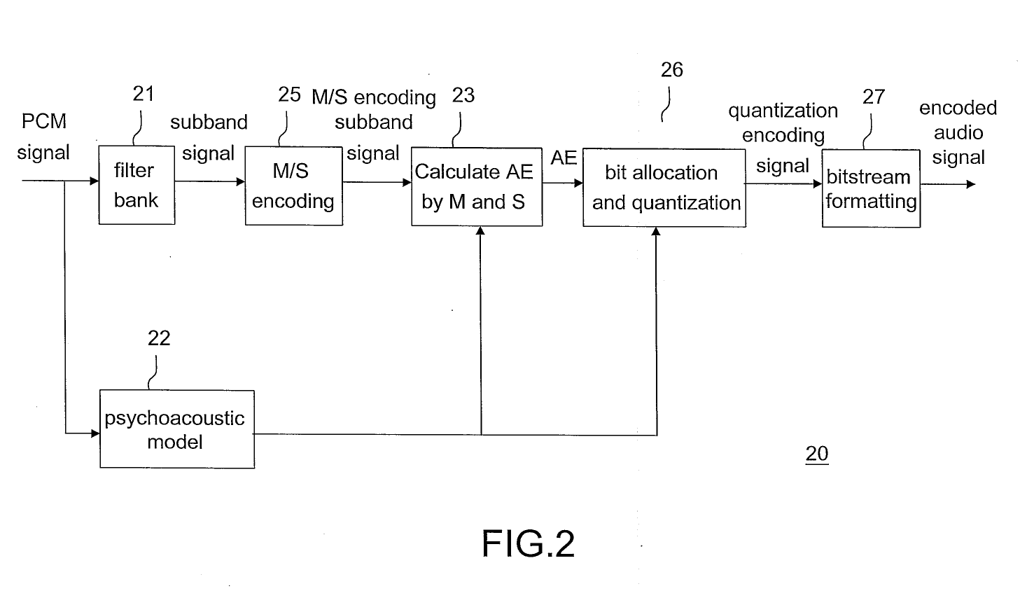

For the convenience of illustration of the present invention, the following audio encoder takes an MP3 encoder as an example, while the time-frequency mapping block takes a multiphase filter bank as an example. FIG. 2 is a block drawing of an MP3 encoder using M/S stereo encoding according to an embodiment of the present invention. Referring to FIG. 2, the MP3 encoder 20 includes a multiphase filter bank 21, a psychoacoustic model block 22, an M/S encoding block 25, a parameter calculation block 23, a bit allocation and quantization block 26 and a bitstream formatting block 27.

The filter bank 21 can map the inputted audio signal (such as a PCM signal) from time domain to frequency domain and divide into a plurality of subband signals, wherein the subband signals are in different subbands, respectively, and the subbands are close to the critical bands of human ears. At the same time, the inputted audio signal is also inputted into the psychoacoustic model block 22, which decides those data that could be abandoned according to some characteristics of human hearing and transfers an analyzed result to the parameter calculation block 23 and the bit allocation and quantization block 26.

The M/S encoding block 25 performs M/S encoding to each subband signal outputted by the filter bank 21 to generate a corresponding M/S encoding subband signal. Then, according to the analysis result of the psychoacoustic model block 22 and the M channel and S channel in the M/S encoding subband signal generated in the M/S encoding block 25, the parameter calculation block 23 generates a corresponding AE.

According to the analysis result of the psychoacoustic model block 22 and the AE from the calculations that the parameter calculation block 23 performs to each M/S encoding subband signal, the bit allocation and quantization block 26 performs bit allocation, quantization and encoding to the corresponding M/S encoding subband signal to generate a quantization encoding signal. Last, the bitstream formatting block 27 packs the quantization encoding signals corresponding to each subband signal in a bitstream format, such as MP3 frame, and then outputs the encoded audio signal.

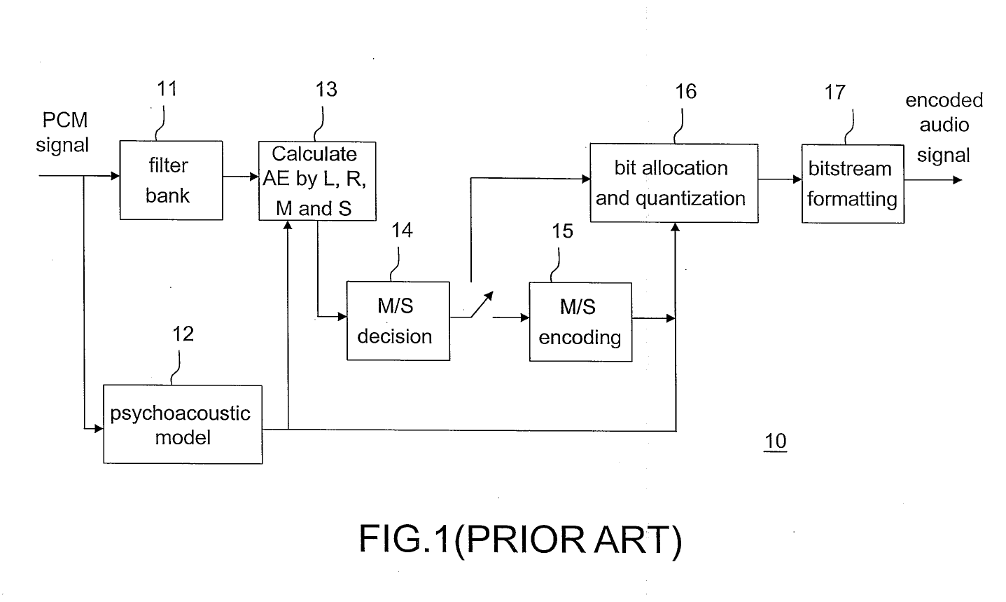

Compared with the MP3 encoder 10 shown in FIG. 1, the MP3 encoder 20 of the present invention does not have the M/S decision block 14 shown in FIG. 1, therefore, the MP3 encoder 20 of the present invention is equivalent to the MP3 encoder 10 shown in FIG. 1, and is forced to operate in M/S mode. Besides, in the MP3 encoder 20 of the present invention, to avoid being encoded twice, the subband signals are first encoded in the M/S encoding block 25, and then calculated in the parameter calculation block 23 to obtain their AE, which is contrary to the order of the corresponding blocks 13 and 15 of the MP3 encoder 10.

In addition, when the MP3 encoder 20 is forced to operate in M/S mode, in the calculation of AE, the parameter calculation block 23 only takes the calculation of M channel and S channel into consideration, and L and R channels are not considered, so that the amount of the calculation can be reduced and the encoding speed can be increased. Besides, the complexity of the psychoacoustic model of the psychoacoustic model block 22 for analyzing the input audio signal can also be reduced.

Table 1 lists eight test signals, which are used to test the MP3 encoder 10 shown in FIG. 1 (Encoder 10 for short below) and the MP3 encoder 20 of the present invention (Encoder 20 for short below). Wherein, these test signals are selected as references for estimating the encoding and decoding quality of perceptual audio by the MPEG committee. The test signals are stereo sounds with a sampling frequency 44.1 kHz and both encoders 10 and 20 operate at 128 k bps (bits per second).

TABLE 1

| File Name | Test Signal | Source |
|---|---|---|
| S1 | Dorita | Lou Reed (Magic and Loss) |
| S2 | We shall be happy | Ry Cooder (Jazz) |
| S3 | Castanets | SQAM |
| S4 | Harpsichord | SQAM |
| S5 | Pitch Pipe | Dolby |
| S6 | Glockenspiel | SQAM |
| S7 | Male German speech | SQAM |
| S8 | Suzanne Vega | Suzanne Vega, Tom's Dinner |

Table 2 lists the respective overall number of frames of the eight test signals, and the number of frames decided to operate in M/S mode (equivalent to Encoder 20) by the M/S decision block 14 of the encoder 10 and the percentage this number takes in the overall number of frames of the test signals. It can be known that, except for the test signal S2, the percentages of the number of frames of the other test signals in M/S mode takes in their overall number of frames are more than 80%.

TABLE 2

| | | | Percent of |
|---|---|---|---|
| | Overall | Number of | Number of frames in M/S |
| | Number of | Frames in M/S | Mode in |
| File Name | Frames | Mode | Overall Number of Frames |
| S1 | 728 | 727 | 99.7 |
| S2 | 642 | 92 | 14.3 |
| S3 | 598 | 598 | 100 |
| S4 | 660 | 561 | 85 |
| S5 | 1049 | 881 | 84 |
| S6 | 832 | 819 | 98.4 |
| S7 | 646 | 646 | 100 |
| S8 | 765 | 762 | 99.6 |

Table 3 respectively lists the perceptual quality of the encoder 10 forced to operate in M/S mode (equivalent to Encoder 20) and the encoder 10 forced not to operate in M/S mode. The test is executed by means of the EAQUAL (Evaluation of Audio Quality) testing program, an open source perceptual quality test tool developed by Alexander Lerch based on the international standard ITU-R BS.1387 for perceptual quality testing. Through the EAQUAL testing program, an objective difference grade (so-called ODG) can be obtained. The values of ODG are from −4 to 0, wherein −4 means a very harsh sound (viz. the worst perceptual quality) while 0 means that no difference from the original audio can be detected (viz. the best perceptual quality).

TABLE 3

| | | ODG of the encoder | ODG of the encoder |
|---|---|---|---|
| | ODG of | 10 forced to operate in | 10 forced not to |
| File Name | Encoder 10 | M/S mode | operate in M/S mode |
| S1 | −0.88 | −0.91 | −1.19 |
| S2 | −1.09 | −1.24 | −1.07 |
| S3 | −0.84 | −0.91 | −1.01 |
| S4 | −0.79 | −0.78 | −0.89 |
| S5 | −1.47 | −1.46 | −1.52 |
| S6 | −0.40 | −0.41 | −0.51 |
| S7 | −0.39 | −0.43 | −1.01 |
| S8 | −0.27 | −0.26 | −1.04 |

It can be known from Table 3 that the M/S encoding method used in Encoder 20 of the present invention can improve the encoding quality, and the improved effect is especially obvious for speech signals (such as the test signals S7 and S8). Saving the M/S decision and the AE calculation of L and R channels, this M/S encoding method forcing the operation in M/S mode can be accepted despite a little decreasing of the whole encoding quality; that is, the frequency width and memory of a real-time MP3 encoder are limited, so the aforementioned saving method is very important.

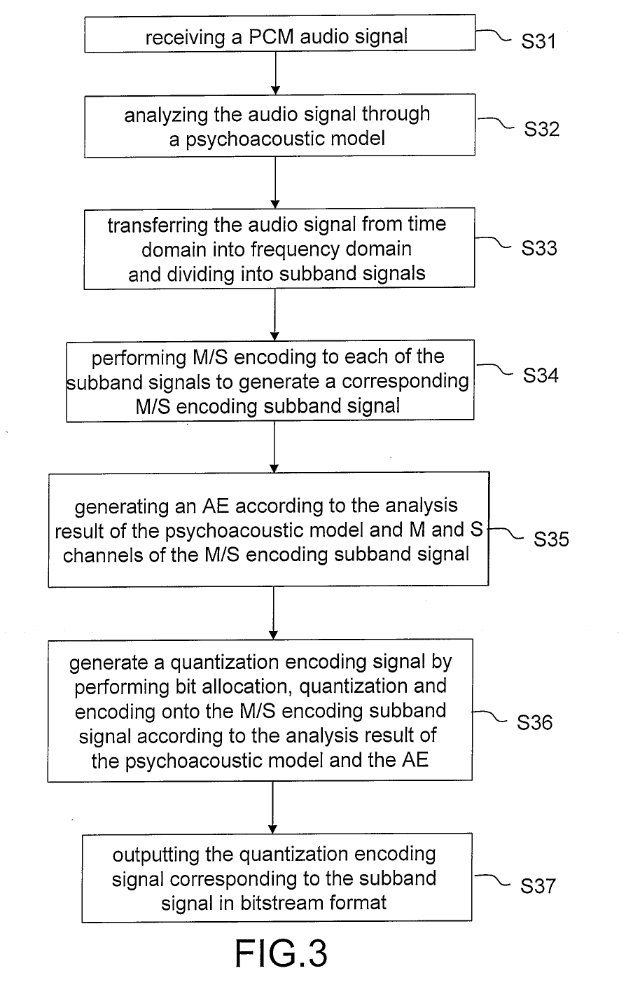

FIG. 3 is a flow chart of an M/S stereo encoding method according to an embodiment of the present invention. Referring to FIG. 3, in the method, an audio signal, such as a PCM audio signal, is first received at step S31. At step S32, the audio signal is analyzed through the psychoacoustic model. At step S33, the audio signal is transferred from time domain into frequency domain and divided into a plurality of subband signals. And then, at step S34, each of the subband signals is M/S encoded to generate a corresponding M/S encoding subband signal. Next, at step S35, according to the analysis result of the psychoacoustic model and M channel and S channel in the M/S encoding subband signal, an AE corresponding to the M/S encoding subband signal is generated. At step S36, according to the analysis result of the psychoacoustic model and the AE, bit allocation, quantization and encoding are performed onto the M/S encoding subband signal to generate a quantization encoding signal. Last, at step S37, the quantization encoding signal corresponding to the subband signal is outputted in bitstream format.

In summary, in the present invention, the encoder is forced to operate in M/S mode to reduce the calculation time of the parameter used for bit allocation and quantization. In addition, only M and S channels are taken into consideration in the calculation of the parameter, and L and R channels are omitted, thus the complexity of the psychoacoustic model for analyzing the input audio signals can be reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An audio encoder, comprising:
a time-frequency mapping block for receiving an audio signal, mapping the audio signal from time domain to frequency domain and dividing into a plurality of subband signals;
a psychoacoustic model block for receiving the audio signal and analyzing the audio signal by means of a psychoacoustic model;
a middle/side (M/S) encoding block for performing M/S encoding to each of the subband signals to generate a corresponding M/S encoding subband signal;
a parameter calculation block for generating a corresponding allocation entropy according to the analysis result of the psychoacoustic model block and the middle channel and side channel in the M/S encoding subband signal;
a bit allocation and quantization block for performing bit allocation, quantization and encoding to generate a quantization encoding signal according to the analysis result of the psychoacoustic model block and the allocation entropy; and
a bitstream formatting block for outputting the quantization encoding signal corresponding to each of the subband signals in a bitstream format.

2. The audio encoder as claimed in claim 1, wherein the audio encoder is based on the standard of MPEG Audio Layer-3.

3. The audio encoder as claimed in claim 1, wherein the time-frequency mapping block comprises a multiphase filter bank.

4. A method for middle/side (M/S) stereo encoding, comprising:
receiving an audio signal;
analyzing the audio signal through a psychoacoustic model;
mapping the audio signal from time domain to frequency domain and dividing into a plurality of subband signals;
performing M/S encoding to each of the subband signals to generate a corresponding M/S encoding subband signal;
generating an allocation entropy according to the analysis result of the psychoacoustic model and the middle channel and side channel in the M/S encoding subband signal;
performing bit allocation, quantization and encoding to generate a quantization encoding signal according to the analysis result of the psychoacoustic model and the allocation entropy; and
outputting the quantization encoding signal corresponding to each of the subband signals in a bitstream format.

5. The method for M/S stereo encoding as claimed in claim 4, wherein the method for M/S stereo encoding is based on the standard of MPEG Audio Layer-3.
